(19) United States
(12) Patent Application Publication
(10) Pub. No.: US 2026/0034689 A1
(43) Pub. Date: Feb. 5, 2026

(54) ELECTRIC SHAVER

(71) Applicant: Raymond (Panyu Nansha) Electrical Appliances Development Co., Ltd., Guangzhou (CN)

(72) Inventor: Ying Man John Wong, Guangzhou (CN)

(21) Appl. No.: 19/052,471

(22) Filed: Feb. 13, 2025

(30) Foreign Application Priority Data
Jul. 31, 2024 (CN) 2024218299159
Aug. 16, 2024 (CN) 2024219877584

(51) Int. Cl. B26B 19/04; B26B 19/38

(52) U.S. Cl. CPC B26B 19/048; B26B 19/046; B26B 19/38

(57) ABSTRACT

An electric shaver includes: a head part, a main body, and a connecting seat. The head part is provided with a first sliding seat capable of transversely sliding back and forth and a first tool carrier configured to install a moving blade. The main body is provided with a drive device with an output shaft therein, a top of the first sliding seat is connected with the first tool carrier, and a bottom of the first sliding seat is connected with the output shaft. After the output shaft rotates, the first sliding seat can be driven to slide back and forth transversely. An end of the connecting seat is connected with the main body, and the other end of the connecting seat is hinged with the head part along a transverse hinge shaft. The shaving ability of the electric shaver is stronger and the user experience is better.

### CROSS-REFERENCE TO RELATED APPLICATIONS

This application claims priority to Chinese Patent Application No. 202421829915.9, filed Jul. 31, 2024, and Chinese Patent Application No. 202421987758.4, filed Aug. 16, 2024, both of which are herein incorporated by reference in their entirety.

### TECHNICAL FIELD

The disclosure relates to the technical filed of electric shavers, and more particularly to an electric shaver.

### BACKGROUND

Electric shaver is an electrical appliance that uses electricity to drive blades to shave beards and sideburns, among which a reciprocating electric shaver is a typical one. A shaving head (also referred to as blade head) of this electric shaver is installed on an upper part of a main body of the electric shaver, and the main body is composed of a drive device, a power supply and an operating switch. The drive device drives the shaving head to swing back and forth under the electric drive, and a moving blade cooperates with a fixed static blade to shave off beards and sideburns.

Due to the limitation of structural design, the shaving head of traditional electric shaver often keeps a fixed angle with the main body and cannot be adjusted. In this way, when users use it for shaving, in order to make the shaving head fit the beards in different parts of the face, they can only change the angle of the shaving head relative to the face by swinging the main body with their hands, which reduces the shaving ability and user experience of the shaver to a certain extent.

### SUMMARY

In view of this, the purpose of the disclosure is to provide an electric shaver, which solves the problem that the shaving head of the traditional electric shaver often keeps a fixed angle with the main body, and the users can only change the angle of the shaving head relative to the face by manually swinging the main body.

In order to solve the above technical problems, the technical schemes provided by the disclosure are as follows.

An electric shaver includes a head part and a main body; the head part is provided with a first sliding seat capable of transversely sliding back and forth and a first tool carrier (also referred to as blade carrier) configured to install a moving blade; the main body is provided with a drive device therein, and the drive device is provided with an output shaft; the electric shaver further includes a connecting seat, a top of the first sliding seat is connected with the first tool carrier, a bottom of the first sliding seat is connected with the output shaft, the output shaft is capable of driving the first sliding seat to transversely slide back and forth after rotating, an end of the connecting seat is connected with the main body, and another end of the connecting seat is hinged with the head part along a transverse hinge shaft.

Preferably, the head part is provided with a mounting bracket, a first sliding rod is transversely disposed on the mounting bracket, the first sliding seat is sleeved on the first sliding rod and is slidably connected with the first sliding rod, the top of the first sliding seat is provided with a first connecting element, and the first connecting element is connected with the first tool carrier.

Further preferably, a bottom of the mounting bracket is provided with a first seat plate and a second seat plate, two ends of the first sliding rod are respectively connected with the first seat plate and the second seat plate, the first seat plate defines a first guiding through-hole, and the second seat plate defines a second guiding through-hole; and
an end of the first sliding seat is provided with a first guiding shaft extending along a sliding direction of the first sliding seat, and another end of the first sliding seat is provided with a second guiding shaft extending along the sliding direction of the first sliding seat, the first guiding shaft penetrates through the first guiding through-hole, and the second guiding shaft penetrates through the second guiding through-hole.

Even more preferably, a free end of the first guiding shaft and/or the second guiding shaft is forked;
and/or, the head part of the electric shaver is further provided with a second tool carrier configured to install a moving blade, a second sliding rod is transversely disposed on the mounting bracket, two ends of the second sliding rod are respectively connected with the first seat plate and the second seat plate, a second sliding seat is sleeved on the second sliding rod and is slidably connected with the second sliding rod, and a top of the second sliding seat is provided with a second connecting element configured to connect the second tool carrier;
the mounting bracket is further provided with a third connecting element, an end of the third connecting element is hinged with the first sliding seat, another end of the third connecting element is hinged with the second sliding seat, and a middle part of the third connecting element is rotatably connected with the mounting bracket.

Even more preferably, an end of the second sliding seat is provided with a third guiding shaft extending along a sliding direction of the second sliding seat, another end of the second sliding seat is provided with a fourth guiding shaft extending along the sliding direction of the second sliding seat, the third guiding shaft penetrates through the first guiding through-hole, and the fourth guiding shaft penetrates through the second guiding through-hole;
and/or, a first fixing seat is disposed on the bottom of the mounting bracket, a first fixing shaft is embedded in the first fixing seat, the first fixing shaft extends out of the first fixing seat, is inserted into the third connecting element, and is rotatably connected with the third connecting element;
and/or, at least one of the first sliding rod and the second sliding rod is a metal rod with a smooth surface. Even more preferably, a free end of the third guiding shaft and/or the fourth guiding shaft is forked;
and/or, an outer surface of the first fixing seat is provided with a first rib plate, and the first rib plate extends to the first guiding through-hole and is connected with the first seat plate.

Even more preferably, the mounting bracket is further provided with a fourth connecting element, the third connecting element and the fourth connecting element are arranged at intervals along the sliding direction of the first sliding seat, an end of the fourth connecting element is hinged with the first sliding seat, another end of the fourth connecting element is hinged with the second sliding seat, and a middle part of the fourth connecting element is rotatably connected with the mounting bracket.

Even more preferably, a second fixing seat is disposed on the bottom of the mounting bracket, a second fixing shaft is embedded in the second fixing seat, the second fixing shaft extends out of the second fixing seat, is inserted into the fourth connecting element, and is rotatably connected with the fourth connecting element.

Even more preferably, an outer surface of the second fixing seat is provided with a second rib plate, and the second rib plate extends to the second guiding through-hole and is connected with the second seat plate.

Another preferably, a second sliding rod is transversely disposed on the mounting bracket and is parallel to the first sliding rod, and the first sliding seat is provided with a first support arm which is slidably connected with the second sliding rod.

Further preferably, an end of the first support arm facing towards the second sliding rod is a Y-shaped first opening, and the second sliding rod is inserted into and slidably connected with the first opening; and/or
at least one of the first sliding rod and the second sliding rod is a metal rod with a smooth surface.

Further preferably, a second sliding seat is sleeved on the second sliding rod, and is slidably connected with the second sliding rod, the mounting bracket is further provided with a third connecting element, an end of the third connecting element is hinged with the first sliding seat, and another end of the third connecting element is hinged with the second sliding seat, and a middle part of the third connecting element is rotatably connected with the mounting bracket; and
a second connecting element is disposed on a top of the second sliding seat and penetrates through the mounting bracket, the head part is further provided with a second tool carrier configured to install a moving blade, and the second connecting element is connected with the second tool carrier.

Even more preferably, the second sliding seat defines a first limit groove, the first support arm is provided with a first stop block, and the first stop block is capable of sliding back and forth in the first limit groove;
and/or, the second sliding seat is provided with a second support arm, and the second support arm is slidably connected with the first sliding rod;
and/or, the mounting bracket is further provided with a fourth connecting element, the third connecting element and the fourth connecting element are arranged at intervals along the sliding direction of the first sliding seat, an end of the fourth connecting element is hinged with the first sliding seat, another end of the fourth connecting element is hinged with the second sliding seat, and a middle part of the fourth connecting element is rotatably connected with the mounting bracket;
and/or, the second connecting element comprises at least one connecting column arranged vertically and at intervals.

Even more preferably, an end of the second support arm facing towards the first sliding rod is a Y-shaped second opening, and the first sliding rod is inserted into and slidably connected with the second opening;
and/or, the first sliding seat defines a second limit groove, and the second support arm is provided with a second stop block, and the second stop block is capable of sliding back and forth in the second limit groove.

Even more preferably, the bottom of the mounting bracket is provided with a first fixing seat and a second fixing seat, and the first fixing seat and the second fixing seat are both disposed between the first sliding seat and the second sliding seat;

the first fixing seat is embedded with a first fixing shaft, the first fixing shaft extends out of the first fixing seat, is inserted into the third connecting element, and is rotatably connected with the third connecting element; and

the second fixing seat is embedded with a second fixing shaft, the second fixing shaft extends out of the second fixing seat, is inserted into the fourth connecting element, and is rotatably connected with the fourth connecting element.

Another preferably, the bottom of the first sliding seat defines a snapping groove extending in a longitudinal direction, and the output shaft is rotatably connected with the first sliding seat after being inserted into the snapping groove.

Further preferably, the mounting bracket defines a through-hole, a sealing film covers the through-hole, and the first connecting element sequentially penetrates through the through-hole and the sealing film;
and/or, the first connecting element comprises at least one connecting column arranged vertically and at intervals.

Even more preferably, the top of the mounting bracket is provided with a fixing plate, and the sealing film is fixed after the fixing plate is detachably connected with the mounting bracket.

Compared to the related art, the electric shaver provided by the disclosure has the following beneficial effects.

The top of the first sliding seat of the electric shaver is connected with the first tool carrier, and the first sliding seat is connected with the output shaft. When the output shaft rotates, the first sliding seat can be driven to transversely slide back and forth relative to the main body of the electric shaver, thereby driving the first tool carrier to transversely slide back and forth to realize the shaving function.

By providing the connecting seat, the end of the connecting seat is connected with the main body, and the other end of the connecting seat is hinged with the head part along the transverse hinge shaft, the angle of the head part relative to the main body can be changed in the longitudinal plane, when a user uses it for shaving, the first tool carrier can adaptively rotate due to the rotation of the head part, so that the angle relative to the main body can be adjusted independently to adapt to the change of the facial curve, which can solve the problem that the shaving head of the traditional electric shaver often keeps a fixed angle with the main body, and the user can only change the angle of the shaving head relative to the face by manually swinging the main body, and the transverse reciprocating movement of the first tool carrier will not be affected because the hinge shaft which is consistent with the reciprocating sliding direction of the first tool carrier is adopted.

Because the shaving head part of the electric shaver of the disclosure can adaptively change the angle relative to the main body as the user moves it on the face, the top side of the shaving head part can adaptively fit the face, so that the shaving ability is stronger and the user experience is better.

### BRIEF DESCRIPTION OF DRAWINGS

Through the preferred embodiments of the disclosure shown in the accompanying drawings, the above and other objectives, features, and advantages of the disclosure will become clearer. The same reference numerals in all the drawings indicate the same parts, and the drawings are not intentionally scaled proportionally according to actual dimensions. The focus is on illustrating the essence of the disclosure.

FIG. 1 illustrates a schematic structural diagram of an electric shaver according to an embodiment of the disclosure (head part faces upward).

FIG. 2 illustrates a first schematic internal structural diagram of the electric shaver illustrated in FIG. 1.

FIG. 3 illustrates a second schematic internal structural diagram of the electric shaver illustrated in FIG. 1.

FIG. 4 illustrates a third schematic internal structural diagram of the electric shaver illustrated in FIG. 1.

FIG. 5 illustrates a schematic structural diagram of an electric shaver according to the embodiment of the disclosure (head part rotates downward).

FIG. 6 illustrates a first schematic internal structural diagram of the electric shaver illustrated in FIG. 5.

FIG. 7 illustrates a second schematic internal structural diagram of the electric shaver illustrated in FIG. 5.

FIG. 8 illustrates a third schematic internal structural diagram of the electric shaver illustrated in FIG. 5.

FIG. 9 illustrates a schematic structural diagram of a mounting bracket according to a first embodiment of the disclosure.

FIG. 10 illustrates a schematic structural diagram of a first sliding seat according to the first embodiment of the disclosure.

FIG. 11 illustrates a schematic structural diagram of a second sliding seat according to the first embodiment of the disclosure.

FIG. 12 illustrates a schematic structural diagram of a third connecting element and a fourth connecting element according to the embodiment of the disclosure.

FIG. 13 illustrates a schematic structural diagram of the assembled structure illustrated in FIGS. 9 to 12 according to the first embodiment of the disclosure.

FIG. 14 illustrates a schematic structural diagram of a mounting bracket according to a second embodiment of the disclosure.

FIG. 15 illustrates a schematic structural diagram of a first sliding seat according to the second embodiment of the disclosure.

FIG. 16 illustrates a schematic structural diagram of a second sliding seat according to the second embodiment of the disclosure.

FIG. 17 illustrates a schematic structural diagram of the assembled structure illustrated in FIGS. 12 and 14 to 16 according to the second embodiment of the disclosure.

FIG. 18 illustrates another schematic structural diagram of the assembled structure illustrated in FIGS. 9 to 12 according to the first embodiment of the disclosure.

FIG. 19 illustrates another schematic structural diagram of the assembled structure illustrated in FIGS. 12 and 14 to 16 according to the second embodiment of the disclosure.

### DESCRIPTION OF REFERENCE NUMERALS:

100: head part; 200: main body; 300: mounting bracket; 400: connecting seat;
1: first sliding rod; 2: first sliding seat; 3: first connecting element; 4: output shaft; 5: snapping groove; 501: baffle; 6: first seat plate; 7: second seat plate; 8: first guiding through-hole; 9: second guiding through-hole; 10: first guiding shaft; 11: second guiding shaft; 12: hollow groove; 13: second sliding rod; 14: second sliding seat; 15: second connecting element; 16: third connecting element; 17: fourth connecting element; 18: first fixing seat; 19: second fixing seat; 20: first rib plate; 21: second rid plate; 22: through-hole; 23: third guiding shaft; 24: fourth guiding shaft; 25: hinge shaft; 26: first tool carrier; 27: second tool carrier; 28: third tool carrier; 29: first support arm; 30: second support arm; 31: first opening; 32: second opening; 33: first limit groove; 34: second limit groove; 35: first stop block; 36: second stop block; 37: first connecting column; 38: second connecting column; 39: first fixing shaft; 40: second fixing shaft; 41: sealing film; 42: fixing plate.

### DETAILED DESCRIPTION OF EMBODIMENTS

The following provides a further detailed description of the technical solutions of the disclosure in conjunction with the accompanying drawings and specific embodiments, in order to enable those skilled in the art to better understand and implement the disclosure. However, the illustrated embodiments are not intended to limit the disclosure. In the embodiments, it should be understood that the terms “longitudinal”, “transverse”, “up”, “down”, “front”, “back”, “left”, “right”, “vertical”, “horizontal”, “top”, “bottom”, “inside”, “outside” and other directional or positional relationships indicated are based on the directional or positional relationships shown in the accompanying drawings, and are only for the convenience of describing the disclosure, rather than indicating or implying that the device or component must have a specific orientation, be constructed and operated in a specific orientation, and therefore cannot be understood as limiting the disclosure.

It should be noted that when a component is considered to be “connected” to another component, it can be directly connected to another component and integrated with it, or there may be a middle component present at the same time. The terms “installed”, “one end”, “the other end” and similar expressions used in the disclosure are for illustrative purposes only.

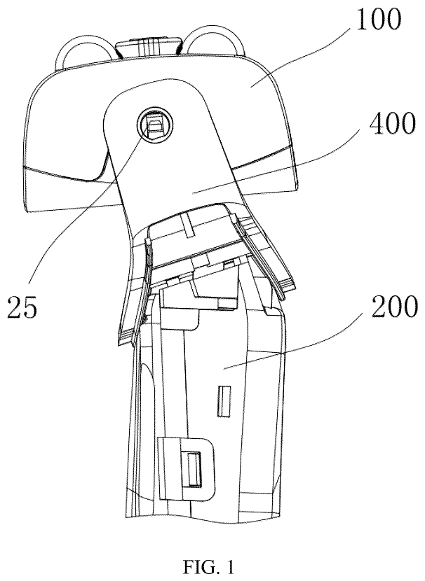

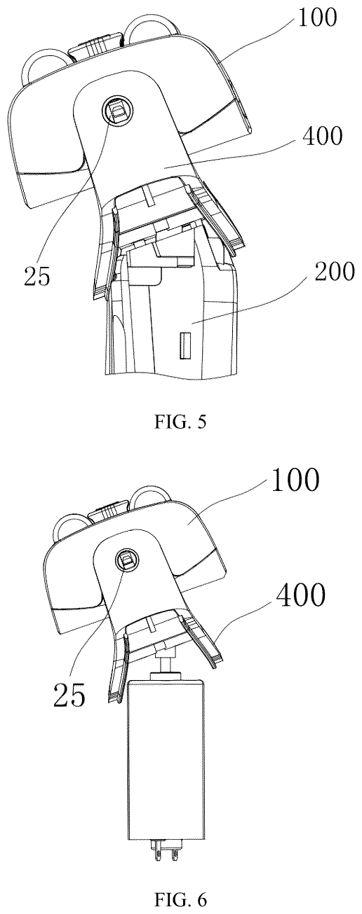

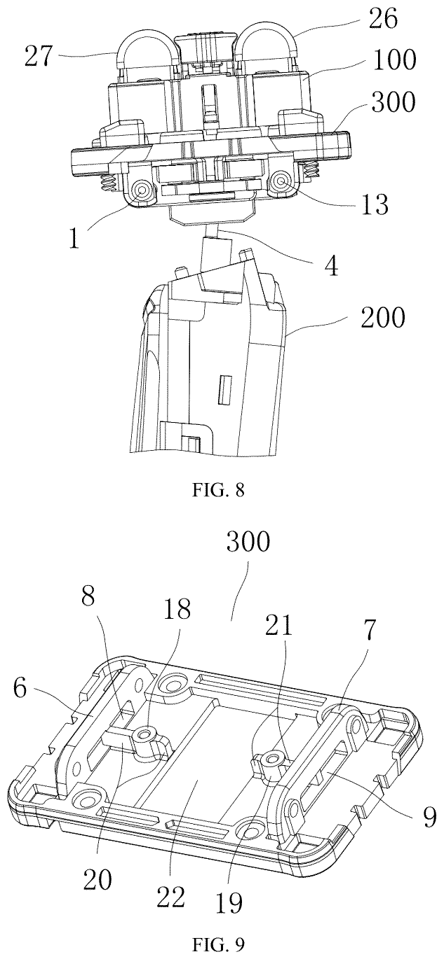

An embodiment provides an electric shaver, as illustrated in FIGS. 1 to 8, which includes a head part 100, a main body 200 and a connecting seat 400. The head part 100 is provided with a first sliding seat 2 capable of transversely sliding back and forth and a first tool carrier 26 configured to install a moving blade. The main body 200 is provided with a drive device therein, and the drive device is provided with an output shaft 4. The top of the first sliding seat 2 is connected with the first tool carrier 26, and the bottom of the first sliding seat 2 is connected with the output shaft 4. After the output shaft 4 rotates, it can drive the first sliding seat 2 to slide back and forth transversely. An end of the connecting seat 400 is connected with the main body 200, and the other end of the connecting seat 400 is hinged with the head part 100 along the transverse hinge shaft 25.

The top of the first sliding seat 2 of the electric shaver provided by the disclosure is connected with the first tool carrier 26, and the first sliding seat 26 is connected with the output shaft 4. When the output shaft 4 rotates, the first sliding seat 2 can be driven to transversely slide back and forth relative to the main body 200, thereby driving the first tool carrier 26 to transversely slide back and forth to realize the shaving function.

By providing the connecting seat 400, the end of the connecting seat 400 is connected with the main body 200, and the other end of the connecting seat 400 is hinged with the head part 100 along the transverse hinge shaft 25, the angle of the head part 100 relative to the main body 200 can be changed in the longitudinal plane, when a user uses it for shaving, the first tool carrier 26 can adaptively rotate due to the rotation of the head part 100, so that the angle relative to the main body 200 can be adjusted independently to adapt to the change of the facial curve, which can solve the problem that the shaving head of the traditional electric shaver often keeps a fixed angle with the main body, and the user can only change the angle of the shaving head relative to the face by manually swinging the main body, and the transverse reciprocating movement of the first tool carrier 26 will not be affected because the hinge shaft 25 which is consistent with the reciprocating sliding direction of the first tool carrier 26 is adopted.

Because the head part of the shaver of the disclosure can adaptively change the angle relative to the main body 200 as the user moves it on the face, the top side of the head part can adaptively fit the face, so that the shaving ability is stronger and the user experience is better.

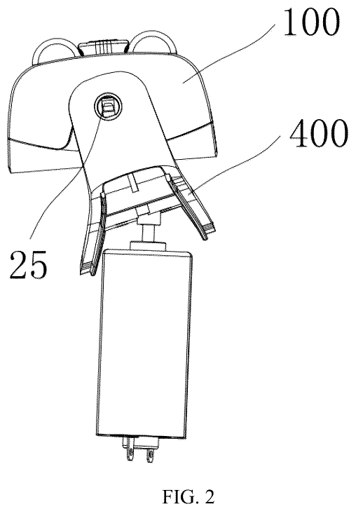

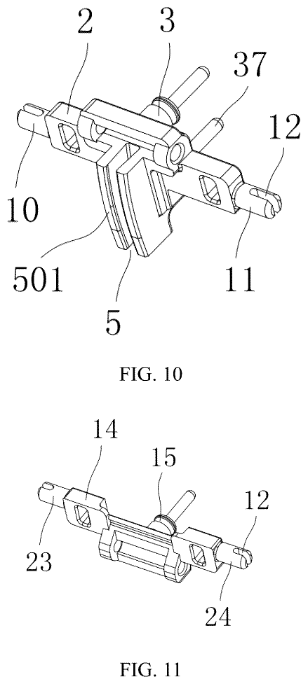

In a preferred embodiment, as illustrated in FIGS. 2 and 10, the bottom of the first sliding seat 2 defines a snapping groove 5 extending in a longitudinal direction, and the output shaft 4 is rotatably connected with the first sliding seat 2 after being inserted into the snapping groove 5. Specifically, the snapping groove 5 is defined by two parallel and spaced baffles 501, and the output shaft 4 is connected with an eccentric shaft which is inserted between the two baffles 501. When the eccentric shaft rotates, it can repeatedly push the two baffles 501, thereby driving the first sliding seat 2 to slide back and forth.

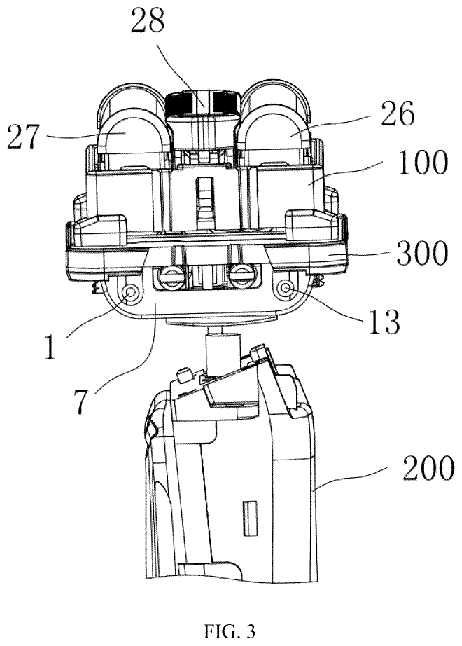

In another preferred embodiment, as illustrated in FIGS. 3 and 9, the head part 100 is provided with a mounting bracket 300, the mounting bracket 300 is transversely provided with a first sliding rod 1, the first sliding seat 2 is sleeved on and slidably connected with the first sliding rod 1, the top of the first sliding seat 2 is provided with a first connecting element 3 penetrating through the mounting bracket 300, and the first connecting element 3 is connected with the first tool carrier 26. In a specific embodiment, the mounting bracket 300 defines a through-hole 22, a sealing film 41 is provided to cover the through-hole 22, the first connecting element 3 passes through the through-hole 22 and the sealing film 41 in turn. By providing the sealing film 41, the beard residue can be prevented from falling from the through-hole 22, so as to affect the smoothness of mechanical fit. Specifically, the first connecting element 3 includes at least one first connecting column 37 arranged vertically and at intervals. It should be noted that the first connecting column 37 needs to move back and forth, so the sealing film 41 penetrated by the first connecting column 37 must have free deformation ability at least within the reciprocating distance of the first connecting column 37, and cannot hinder the reciprocating movement of the first connecting column 37. Furthermore, a fixing plate 42 is disposed at the top of the mounting bracket 300, and the sealing film 41 is fixed after the fixing plate 42 is detachably connected with the mounting bracket 300. In further preferred embodiments, the provided technical solutions are as follows.

### First Embodiment

As shown in FIG. 10, in this embodiment, the first connecting element 3 at the top of the first sliding seat 2 includes two first connecting columns 37 arranged at intervals, one of the two first connecting columns 37 is connected with the first tool carrier 26, and the other first connecting column 37 can be connected with the third tool carrier 28 for connecting and installing a moving blade, thus supporting the design of a shaver with three tool carriers. It should be noted that at this time, the two first connecting columns 37 keep synchronous and slide in the same direction.

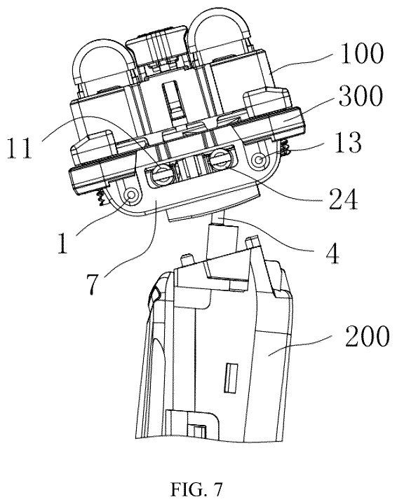

As shown in FIGS. 7 and 9, the bottom of the mounting bracket 300 is provided with a first seat plate 6 and a second seat plate 7, two ends of the first sliding rod 1 are respectively connected with the first seat plate 6 and the second seat plate 7, the first seat plate 6 defines a first guiding through-hole 8, and the second seat plate 7 defines a second guiding through-hole 9. The end of the first sliding seat 2 is provided with a first guiding shaft 10 extending along a sliding direction of the first sliding seat 2, and the other end of the first sliding seat 2 is provided with a second guiding shaft 11 extending along the sliding direction of the first sliding seat 2. The first guiding shaft 10 passes through the first guiding through-hole 8 and the second guiding shaft 11 passes through the second guiding through-hole 9. During the lateral reciprocating sliding of the first sliding seat 2, the first guiding shaft 10 can slide back and forth in the first guiding through-hole 8 and the second guiding shaft 11 can slide back and forth in the second guiding through-hole 9, which can improve the directional stability of the lateral sliding of the first sliding seat 2 and reduce the vibration. As a preferred example, the first guiding shaft 10 and the second guiding shaft 11 are integrally formed with the first sliding seat 2 as one whole.

Furthermore, when the first guiding shaft 10 and the second guiding shaft 11 are machined by processes such as plastic injection molding, machining tolerances will inevitably exist. If the machined size is too small, there will be gaps between the guiding shafts and the corresponding guiding through-holes, and the guiding effect will be reduced. If the machined size is too large, there will be greater friction between the guiding shafts and the corresponding guiding through-holes, and even collision and extrusion will occur with the corresponding guiding through-holes, which is not conducive to vibration and noise reduction, and also will shorten the service life of parts. Therefore, in a preferred embodiment, as shown in FIG. 10, free ends of the first guiding shaft 10 and the second guiding shaft 11 are set in the form of open forks. In this embodiment, an end portion of the first guiding shaft 10 facing towards the first guiding through-hole 8 forms a left part and a right part, and a hollow groove 12 is formed between the left part and the right part, which is the deformation space of the left part and the right part of the first guiding shaft 10. When the first guiding shaft 10 slides in the first guiding through-hole 8, the left and right parts are squeezed by the hole wall, they can be deformed through the hollow groove 12, so that the problem of oversize machining can be solved, and the vibration and noise can be reduced and the service life can be prolonged. The principle that the end portion of the second guiding shaft 11 facing towards the second guiding through-hole 9 forms a left part and a right part is the same as above, and will not be described again. Of course, in other embodiments, the free end of the first guiding shaft 10 or the second guiding shaft 11 can be set to more than three parts in the circumferential direction, and a gap for deformation after extrusion can be formed between every two adjacent parts.

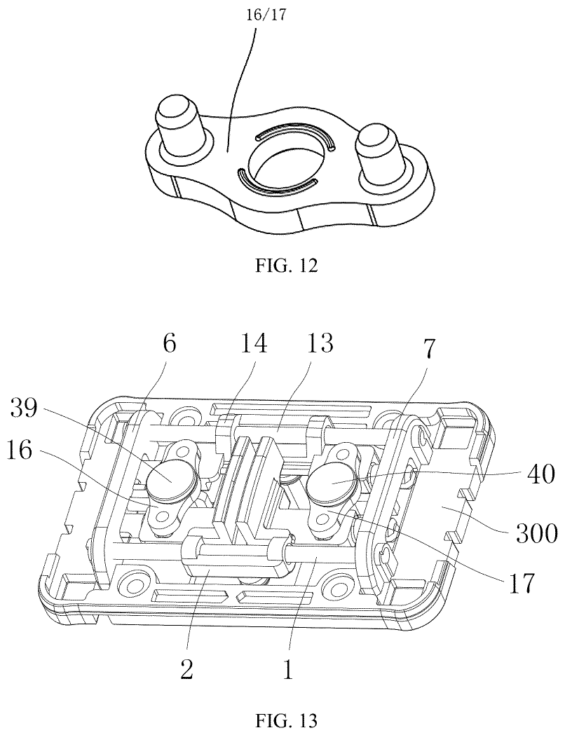

As shown in FIGS. 3, 9, 11, and 12, the head part 100 of the electric shaver is further provided with a second tool carrier 27 configured to install a moving blade. The mounting bracket 300 is further horizontally provided with a second sliding rod 13, and two ends of the second sliding rod 13 are respectively connected to the first seat plate 6 and the second seat plate 7. A second sliding seat 14 is sleeved on the second sliding rod 13 and is slidably connected to the second sliding rod 13. A top of the second sliding seat 14 is provided with a second connecting element 15 configured to connect the second tool carrier 27. The mounting bracket 300 is further provided with a third connecting element 16, an end of the third connecting element 16 is hinged to the first sliding seat 2, and the other end of the third connecting element 16 is hinged to the second sliding seat 14. A middle part of the third connecting element 16 is rotatably connected to the mounting bracket 300. In this embodiment, the second sliding seat 14 can slide in the opposite direction synchronously with the first sliding seat 2 through the third connecting element 16, thereby driving the second tool carrier 27 to move back and forth. The shaver of this embodiment can support the simultaneous setting of two tool carriers, and the synchronization of the two tool carriers is good and the structural design is compact. Specifically, the bottom of the mounting bracket 300 is provided with a first fixing seat 18, and a first fixing shaft 39 is embedded in the first fixing seat 18. After the first fixing shaft 39 extends out of the first fixing seat 18, it is inserted into the third connecting element 16 and is rotatably connected with the third connecting element 16. Furthermore, the first fixing seat 18 is tubular, and the outer surface of the first fixing seat 18 is provided with first rib plates 20 extending along the radial direction of the first fixing seat 18 at two sides of the first fixing shaft 39, and the first rib plate 20 at one of the two sides of the first fixing shaft 39 extends to the first guiding through-hole 8 and is connected with the first seat plate 6, which not only can improve the stability of the first fixing seat 18, but also can reinforce the first seat plate 6.

Preferably, in order to improve the sliding synchronization between the second sliding seat 14 and the first sliding seat 2, the mounting bracket 300 is further provided with a fourth connecting element 17, the third connecting element 16 and the fourth connecting element 17 are arranged at intervals along the sliding direction of the first sliding seat 2, and an end of the fourth connecting element 17 is hinged with the first sliding seat 2, the other end of the fourth connecting element 17 is hinged with the second sliding seat 14, and a middle part of the fourth connecting element 17 is rotatably connected with the mounting bracket 300. By providing the fourth connecting element 17, the pushing and pulling force on the second sliding seat 14 can be increased, and the synchronization of sliding between the second sliding seat 14 and the first sliding seat 2 can be further ensured. Specifically, as shown in FIG. 13, the third connecting element 16 and the fourth connecting element 17 are symmetrically arranged in parallel and located at two ends of the second sliding seat 14, so that the hinge points of the third connecting element 16 with the first sliding seat 2 and the second sliding seat 14, and the hinge points of the fourth connecting element 17 with the first sliding seat 2 and the second sliding seat 14, respectively, form a parallelogram that can smoothly undergo reciprocating deformation. At the same time, a sufficient space can be reserved between the third connecting element 16 and the fourth connecting element 17 to facilitate the connection structure between the output shaft 4 of the drive device and the first sliding seat 2.

As shown in FIG. 9, the bottom of the mounting bracket 300 is provided with a second fixing seat 19, which is embedded with a second fixing shaft 40. The second fixing shaft 40 extends from the second fixing seat 19, is inserted into the fourth connecting element 17, and is rotatably connected to the fourth connecting element 17. The second fixing seat 19 is tubular, and its outer surface is provided with second rib plates 21 extending radially at two sides of the second fixing shaft 40. The second rib plate 21 at one of the two sides of the second fixing shaft 40 extends to the second guiding through-hole 9 and is connected to the second seat plate 7, which can improve the stability of the second fixing seat 19 and also reinforce the second seat plate 7.

The first sliding rod 1 and the second sliding rod 13 mentioned above are metal rods with smooth surfaces, preferably stainless steel cylinders, which are corrosion-resistant, not easily deformed, and have a relatively low friction coefficient on their surfaces, facilitating smooth sliding of the first sliding seat 2 and the second sliding seat 14.

In a preferred embodiment, as shown in FIGS. 7 and 11, an end of the second sliding seat 14 is provided with a third guiding shaft 23 extending along a sliding direction of the second sliding seat 14, and the other end of the second sliding seat 14 is provided with a fourth guiding shaft 24 extending along the sliding direction of the second sliding seat 14. The third guiding shaft 23 passes through the first guide through-hole 8, and the fourth guiding shaft 24 passes through the second guide through-hole 9. As mentioned above, during the lateral reciprocating sliding process of the second sliding seat 14, the third guiding shaft 23 slides back and forth in the first guide through-hole 8, while the fourth guiding shaft 24 slides back and forth in the second guide through-hole 9, which can improve the directional stability of the lateral sliding of the second sliding seat 14 and reduce vibration. It can be understood that the third guiding shaft 23, the fourth guiding shaft 24, and the second sliding seat 14 can also be integrally formed into one whole, and free ends of the third guiding shaft 23 and the fourth guiding shaft 24 can be set in the form of open forks to reduce the vibration generated by the reciprocating movement of the third guiding shaft 23 and the fourth guiding shaft 24 in the first guide through-hole 8 and the second guide through-hole 9 during the high-frequency reciprocating movement of the second sliding seat 14, reduce noise, and extend the service life of the second sliding seat 14.

### Second Embodiment

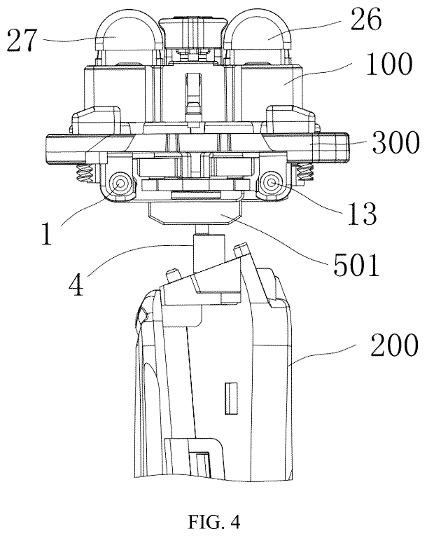

As shown in FIGS. 4, 8, and 14 to 17, the mounting bracket 300 is horizontally provided with a second sliding rod 13 that is parallel to the first sliding rod 1. The first sliding seat 2 is provided with a first support arm 29, which is slidably connected to the second sliding rod 13. By providing the first support arm 29 on the first sliding seat 2 and slidably connecting the first support arm 29 to the second sliding rod 13, the stability of the reciprocating movement of the first sliding seat 2 can be improved, thereby reducing its vibration and noise during high-speed reciprocating movement, enhancing the user experience, and solving the problem of significant vibration and noise caused by the cooperation between transmission structures after starting the electric shaver, which reduces the user experience. Among them, the first sliding rod 1 and/or the second sliding rod 13 are preferably metal rods with smooth surfaces, which can reduce sliding friction and noise, and the metal rods have good rigidity and are not easily deformed. In this embodiment, the first connecting element 3 includes two vertically spaced first connecting columns 37. Increasing the number of first connecting columns 37 can improve the stability of the connection between the first connecting element 3 and the first tool carrier 26, further reducing vibration and noise.

In a preferred embodiment, as shown in FIG. 15, an end of the first support arm 29 facing towards the second sliding rod 13 is a Y-shaped first opening 31, and the second sliding rod 13 is inserted into the first opening 31 and slidably connected to the first opening 31. This not only facilitates the sliding connection between the first support arm 29 and the second sliding rod 13, but also reduces the difficulty of controlling the machining accuracy of the first opening 31.

Further preferably, as shown in FIG. 17, a second sliding seat 14 is sleeved on the second sliding rod 13 and is slidably connected to the second sliding rod 13, and the mounting bracket 300 is further provided with a third connecting element 16. An end of the third connecting element 16 is hinged to the first sliding seat 2, and the other end of the third connecting element 16 is hinged to the second sliding seat 14. A middle part of the third connecting element 16 is rotatably connected to the mounting bracket 300. A top of the second sliding seat 14 is provided with a second connecting element 15 that penetrates the mounting bracket 300. The head part 100 of the electric shaver is further provided with a second tool carrier 27 configured to install a moving blade, and the second connecting element 15 is connected to the second tool carrier 27. In this embodiment, the second sliding seat 14 can slide in the opposite direction synchronously with the first sliding seat 2 through the driving of the third connecting element 16, thereby driving the second connecting element 15 and second tool carrier 27 to move back and forth. The transmission component of this embodiment can support the simultaneous setting of two tool carriers, and the synchronization of the two tool carriers is good, with a compact structural design.

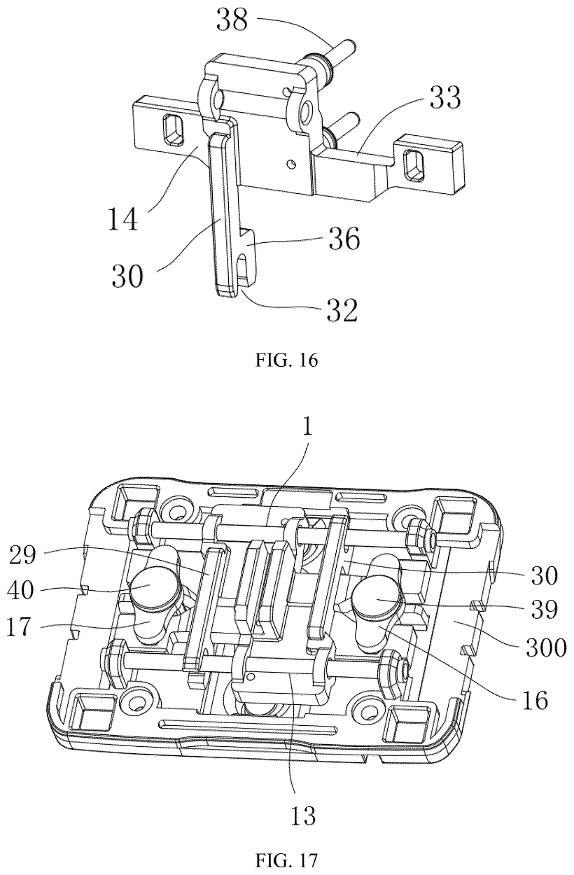

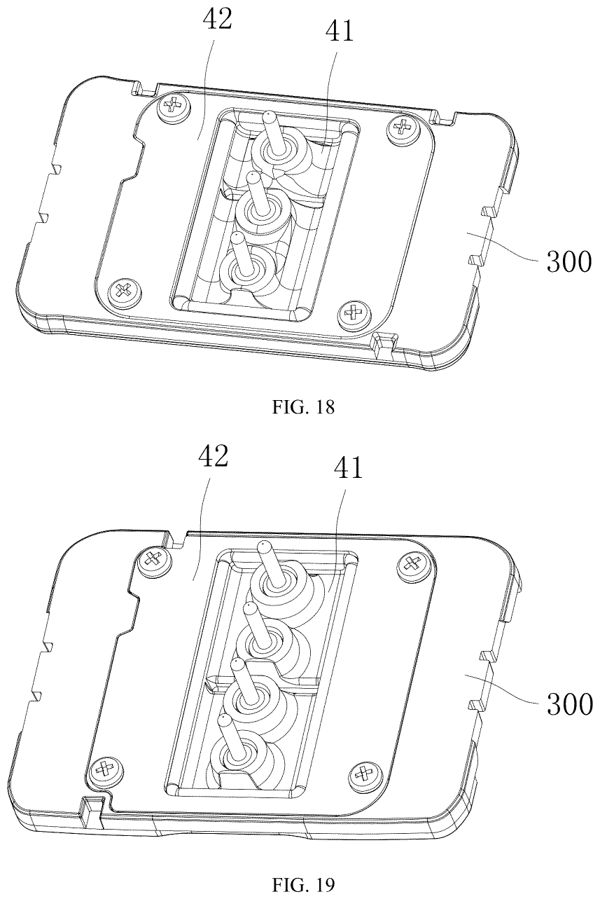

Further preferably, the second connecting element 15 includes at least one vertically spaced second connecting column 38. As described above, similarly, in this embodiment, as shown in FIG. 16, the second connecting element 15 includes two vertically spaced second connecting columns 38. Increasing the number of second connecting columns 38 can improve the stability of the connection between the second connecting element 15 and the second tool carrier 27, which helps to further reduce vibration and noise during operation.

The installation bracket 300 is further provided with a fourth connecting element 17, and the third connecting element 16 and the fourth connecting element 17 are spaced apart along the sliding direction of the first sliding seat 2. An end of the fourth connecting element 17 is hinged to the first sliding seat 2, and the other end of the fourth connecting element 17 is hinged to the second sliding seat 14. A middle part of the fourth connecting element 17 is rotatably connected to the mounting bracket 300. By providing the fourth connecting element 17, the pushing and pulling force on the second sliding seat 14 can be increased, further ensuring the synchronization of the sliding between the second sliding seat 14 and the first sliding seat 2. Specifically, as shown in FIG. 17, the third connecting element 16 and the fourth connecting element 17 are symmetrically arranged in parallel and located at two ends of the second sliding seat 14, so that the hinge points of the third connecting element 16 with the first sliding seat 2 and the second sliding seat 14, and the hinge points of the fourth connecting element 17 with the first sliding seat 2 and the second sliding seat 14, respectively, form a parallelogram that can smoothly undergo reciprocating deformation. At the same time, a sufficient space can be reserved between the third connecting element 16 and the fourth connecting element 17 to facilitate the connection structure between the output shaft 4 of the drive device and the first sliding seat 2.

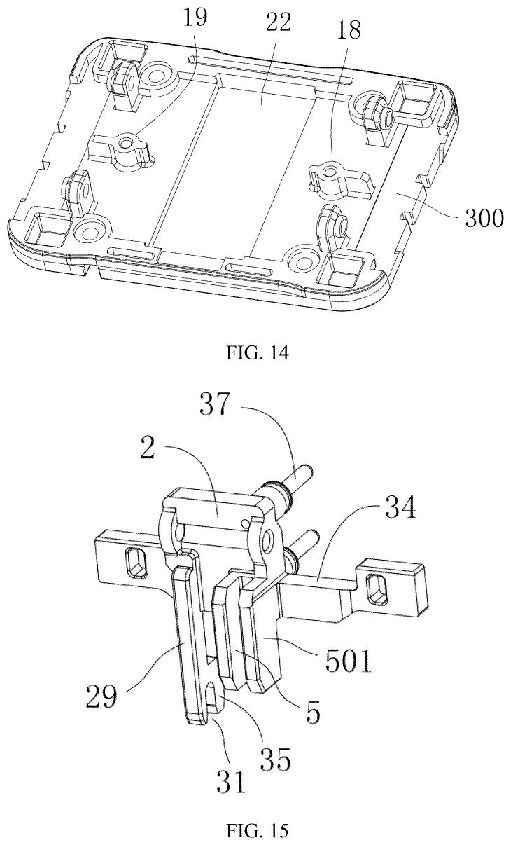

Specifically, as shown in FIG. 14, the bottom of the mounting bracket 300 is provided with a first fixing seat 18 and a second fixing seat 19, both of which are located between the first sliding seat 2 and the second sliding seat 14. The first fixing seat 18 is embedded with a first fixing shaft 39, which extends from the first fixing seat 18, is inserted into the third connecting element 16, and is rotatably connected to the third connecting element 16. The second fixing seat 19 is embedded with a second fixing shaft 40, which extends from the second fixing seat 19, is inserted into the fourth connecting element 17, and is rotatably connected to the fourth connecting element 17.

As shown in FIG. 16, the second sliding seat 14 is provided with a second support arm 30, which is slidably connected to the first sliding rod 1. Similarly, this embodiment can improve the stability of the reciprocating movement of the second sliding seat 14, thereby reducing its vibration and noise generated during high-speed reciprocating movement, which is beneficial for improving the user experience. Furthermore, the end of the second support arm 30 facing towards the first sliding rod 1 is a Y-shaped second opening 32. The first sliding rod 1 is inserted into the second opening 32 and is slidably connected to the second opening 32. Similarly, the sliding connection between the second support arm 30 and the first sliding rod 1 can be quickly achieved, and the difficulty of controlling the machining accuracy of the second opening 32 can also be reduced.

Preferably, the second sliding seat 14 defines a first limit groove 33, and the first support arm 29 is provided with a first stop block 35. The first stop block 35 slides back and forth within the first limit groove 33. By cooperating with the first stop block 35 and the first limit groove 33, the maximum distance of reciprocating sliding of the first sliding seat 2 can be limited, avoiding excessive sliding and improving the response sensitivity during directional sliding.

Similarly, as shown in FIGS. 15 and 17, the first sliding seat 2 defines a second limit groove 34, and the second support arm 30 is provided with a second stop block 36. The second stop block 36 slides back and forth within the second limit groove 34. Through the cooperation between the second stop block 36 and the second limit groove 34, the maximum sliding distance of the second sliding seat 14 can be limited, avoiding excessive sliding and improving the response sensitivity during directional sliding.

It should be noted that the terms such as “top”, “bottom” and “up” in the above description are based on the description of the usual use state when the head part of the shaver is above the main body. It can be understood that when the actual use state of the shaver changes, the above description of the orientation changes accordingly, but it does not mean that these changes will go beyond the scope of the scheme of the disclosure.

In this specification, unless otherwise specified and limited, the first feature being “above” or “below” the second feature may be the direct contact between the first and second features, or the indirect contact between the first and second features through an intermediary. Moreover, the first feature is “above” and “on” the second feature, which can mean that the first feature is directly above or obliquely above the second feature, or just means that the horizontal height of the first feature is higher than the second feature. The first feature is “under” and “below” the first feature, which can mean that the first feature is directly or obliquely below the second feature, or just mean that the horizontal height of the first feature is smaller than the second feature.

In the description of this specification, the reference to terms such as “preferred embodiment”, “further embodiment”, “other embodiments”, or “specific example” means that the specific features, structures, materials, or characteristics described in conjunction with the embodiments or examples are included in at least one embodiment or example of the disclosure. In this specification, the schematic expressions of the above terms do not necessarily refer to the same embodiments or examples. Moreover, the specific features, structures, materials, or characteristics described can be combined in any one or more embodiments or examples in an appropriate manner. In addition, those skilled in the art can combine the different embodiments or examples described in this specification, as well as the features of different embodiments or examples, without conflicting with each other.

Although the embodiments of the disclosure have been shown and described above, it can be understood that the above embodiments are exemplary and should not be construed as limiting the disclosure. Those skilled in the art may make changes, modifications, substitutions, and variations to the above embodiments within the scope of the disclosure.

What is claimed is:

1. An electric shaver, comprising:
a head part, wherein the head part is provided with a first sliding seat capable of transversely sliding back and forth and a first tool carrier configured to install a moving blade;
a main body, wherein the main body is provided with a drive device therein, and the drive device is provided with an output shaft;
a connecting seat, wherein a top of the first sliding seat is connected with the first tool carrier, a bottom of the first sliding seat is connected with the output shaft, the output shaft is capable of driving the first sliding seat to transversely slide back and forth after rotating, an end of the connecting seat is connected with the main body, and another end of the connecting seat is hinged with the head part along a transverse hinge shaft.

2. The electric shaver according to claim 1, wherein the head part is provided with a mounting bracket, a first sliding rod is transversely disposed on the mounting bracket, the first sliding seat is sleeved on the first sliding rod and is slidably connected with the first sliding rod, the top of the first sliding seat is provided with a first connecting element penetrating through the mounting bracket, and the first connecting element is connected with the first tool carrier.

3. The electric shaver according to claim 2, wherein a bottom of the mounting bracket is provided with a first seat plate and a second seat plate, two ends of the first sliding rod are respectively connected with the first seat plate and the second seat plate, the first seat plate defines a first guiding through-hole, and the second seat plate defines a second guiding through-hole; and
an end of the first sliding seat is provided with a first guiding shaft extending along a sliding direction of the first sliding seat, and another end of the first sliding seat is provided with a second guiding shaft extending along the sliding direction of the first sliding seat, the first guiding shaft penetrates through the first guiding through-hole, and the second guiding shaft penetrates through the second guiding through-hole.

4. The electric shaver according to claim 3, wherein
a free end of at least one of the first guiding shaft and the second guiding shaft is forked; and/or
the head part of the electric shaver is further provided with a second tool carrier configured to install a moving blade, a second sliding rod is transversely disposed on the mounting bracket, two ends of the second sliding rod are respectively connected with the first seat plate and the second seat plate, a second sliding seat is sleeved on the second sliding rod and is slidably connected with the second sliding rod, and a top of the second sliding seat is provided with a second connecting element configured to connect the second tool carrier;
the mounting bracket is further provided with a third connecting element, an end of the third connecting element is hinged with the first sliding seat, another end of the third connecting element is hinged with the second sliding seat, and a middle part of the third connecting element is rotatably connected with the mounting bracket.

5. The electric shaver according to claim 4, wherein
an end of the second sliding seat is provided with a third guiding shaft extending along a sliding direction of the second sliding seat, another end of the second sliding seat is provided with a fourth guiding shaft extending along the sliding direction of the second sliding seat, the third guiding shaft penetrates through the first guiding through-hole, and the fourth guiding shaft penetrates through the second guiding through-hole; and/or
a first fixing seat is disposed on the bottom of the mounting bracket, a first fixing shaft is embedded in the first fixing seat, the first fixing shaft extends out of the first fixing seat, is inserted into the third connecting element, and is rotatably connected with the third connecting element; and/or
at least one of the first sliding rod and the second sliding rod is a metal rod with a smooth surface.

6. The electric shaver according to claim 5, wherein
a free end of at least one of the third guiding shaft and the fourth guiding shaft is forked; and/or
an outer surface of the first fixing seat is provided with a first rib plate, and the first rib plate extends to the first guiding through-hole and is connected with the first seat plate.

7. The electric shaver according to claim 4, wherein the mounting bracket is further provided with a fourth connecting element, the third connecting element and the fourth connecting element are arranged at intervals along the sliding direction of the first sliding seat, an end of the fourth connecting element is hinged with the first sliding seat, another end of the fourth connecting element is hinged with the second sliding seat, and a middle part of the fourth connecting element is rotatably connected with the mounting bracket.

8. The electric shaver according to claim 7, wherein a second fixing seat is disposed on the bottom of the mounting bracket, a second fixing shaft is embedded in the second fixing seat, the second fixing shaft extends out of the second fixing seat, is inserted into the fourth connecting element, and is rotatably connected with the fourth connecting element.

9. The electric shaver according to claim 8, wherein an outer surface of the second fixing seat is provided with a second rib plate, and the second rib plate extends to the second guiding through-hole and is connected with the second seat plate.

10. The electric shaver according to claim 2, wherein a second sliding rod is transversely disposed on the mounting bracket and is parallel to the first sliding rod, and the first sliding seat is provided with a first support arm which is slidably connected with the second sliding rod.

11. The electric shaver according to claim 10, wherein
an end of the first support arm facing towards the second sliding rod is a Y-shaped first opening, and the second sliding rod is inserted into and slidably connected with the first opening; and/or
at least one of the first sliding rod and the second sliding rod is a metal rod with a smooth surface.

12. The electric shaver according to claim 10, wherein a second sliding seat is sleeved on the second sliding rod, and is slidably connected with the second sliding rod, the mounting bracket is further provided with a third connecting element, an end of the third connecting element is hinged with the first sliding seat, and another end of the third connecting element is hinged with the second sliding seat, and a middle part of the third connecting element is rotatably connected with the mounting bracket; and
a second connecting element is disposed on a top of the second sliding seat and penetrates through the mounting bracket, the head part is further provided with a second tool carrier configured to install a moving blade, and the second connecting element is connected with the second tool carrier.

13. The electric shaver according to claim 12, wherein
the second sliding seat defines a first limit groove, the first support arm is provided with a first stop block, and the first stop block is capable of sliding back and forth in the first limit groove; and/or
the second sliding seat is provided with a second support arm, and the second support arm is slidably connected with the first sliding rod; and/or
the mounting bracket is further provided with a fourth connecting element, the third connecting element and the fourth connecting element are arranged at intervals along the sliding direction of the first sliding seat, an end of the fourth connecting element is hinged with the first sliding seat, another end of the fourth connecting element is hinged with the second sliding seat, and a middle part of the fourth connecting element is rotatably connected with the mounting bracket; and/or
the second connecting element comprises at least one connecting column arranged vertically and at intervals.

14. The electric shaver according to claim 13, wherein
an end of the second support arm facing towards the first sliding rod is a Y-shaped second opening, and the first sliding rod is inserted into and slidably connected with the second opening; and/or
the first sliding seat defines a second limit groove, and the second support arm is provided with a second stop block, and the second stop block is capable of sliding back and forth in the second limit groove.

15. The electric shaver according to claim 13, wherein the bottom of the mounting bracket is provided with a first fixing seat and a second fixing seat, and the first fixing seat and the second fixing seat are both disposed between the first sliding seat and the second sliding seat;
the first fixing seat is embedded with a first fixing shaft, the first fixing shaft extends out of the first fixing seat, is inserted into the third connecting element, and is rotatably connected with the third connecting element; and
the second fixing seat is embedded with a second fixing shaft, the second fixing shaft extends out of the second fixing seat, is inserted into the fourth connecting element, and is rotatably connected with the fourth connecting element.

16. The electric shaver according to claim 1, wherein the bottom of the first sliding seat defines a snapping groove extending in a longitudinal direction, and the output shaft is rotatably connected with the first sliding seat after being inserted into the snapping groove.

17. The electric shaver according to claim 2, wherein
the mounting bracket defines a through-hole, a sealing film covers the through-hole, and the first connecting element sequentially penetrates through the through-hole and the sealing film; and/or
the first connecting element comprises at least one connecting column arranged vertically and at intervals.

18. The electric shaver according to claim 17, wherein the top of the mounting bracket is provided with a fixing plate, and the sealing film is fixed after the fixing plate is detachably connected with the mounting bracket.
